(19) United States
(12) Patent Application Publication
(10) Pub. No.: US 2004/0253498 A1
(43) Pub. Date: Dec. 16, 2004

(54) Modular fuel reformer with removable carrier

(75) Inventors: William F. Northrop, Somerville, MA (US); Jian L. Zhao, Boston, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Nuvera Fuel Cells, Inc., Cambridge, MA (US)

(21) Appl. No.: 10/825,078

(22) Filed: Apr. 15, 2004

Related U.S. Application Data
(60) Provisional application No. 60/463,127, filed on Apr. 15, 2003.

(51) Int. Cl. H01M 8/10; H01M 8/00; H01M 8/18

(52) U.S. Cl. 429/32; 429/19; 429/13

(57) ABSTRACT

A modular fuel reformer comprising a fuel reformer assembly having a cavity; a removable carrier comprising at least one fuel reformer module, the carrier connecting to the fuel reformer assembly to enclose the at least one module within the cavity; and a connector engageable to secure the carrier and the fuel reformer assembly in fluid-tight relationship and easily disengageable to permit removal of the carrier from the fuel reformer assembly. Any suitable connector can be employed to removably secure the carrier to the fuel reformer assembly, such as a flange with bolt holes, clamps, latches, retaining springs, a threaded connection, nuts and studs, pins, bayonet-type engagements, retaining rings, a chuck or collet, a crimped disposable connector, or any combinations of these. The at least one fuel reformer module preferably comprises a catalyst module containing a catalyst, such as a fuel reforming catalyst, a water gas shift catalyst, a catalyst for removing carbon monoxide or other contaminants, or a catalytic burner catalyst. Serviceability of a fuel reformer is improved by designing the reformer so that catalysts can readily be removed from the reformer for replacement or repair.

### RELATED APPLICATION(S)

This application claims the benefit of U.S. Provisional Application No. 60/463,127, filed Apr. 15, 2003, the entire teachings of which are incorporated herein by reference.

### BACKGROUND OF THE INVENTION

There is considerable interest in using fuel cells in a wide variety of situations. Fuel cells react hydrogen with oxygen to produce electricity. In the absence of a hydrogen distribution infrastructure, it is necessary in many cases to manufacture hydrogen locally for use in fuel cells. This is particularly important in mobile applications, such as motor vehicles, and in small, dispersed applications, such as cogeneration, or supply of electricity at remote sites. Hydrogen is manufactured from conventional fuels, such as petroleum products, alcohols, coal, etc, by the process of steam reforming.

The steam reforming reaction is well known. In this reaction, a fuel in gaseous form, typically a hydrocarbon or an alcohol, is mixed with steam at elevated temperature, usually in the presence of a catalyst. The fuel and water are converted into hydrogen and carbon monoxide. The steam reforming reaction is endothermic (absorbs heat), and so heat must be supplied to the system to drive the reaction. This can be done either by supplying heat from a burner external to the catalyst bed, or by burning some oft the fuel within the bed after adding air or oxygen. The reaction temperature is typically in the range of about 700 to 800 deg. C.

In subsequent reactions the CO (carbon monoxide) is reacted with more H₂O (water) in the presence of a catalyst to form CO₂ (carbon dioxide) and more H₂ (hydrogen gas). This is called the “water gas shift” reaction. The resulting hydrogen-containing gas, generally called the reformate, is used for various purposes, but particularly for the generation of electricity using a fuel cell. In many cases, additional stages of catalytic CO removal, and removal of other contaminants such as sulfur and ammonia by absorption or catalysis, are required to avoid poisoning the catalysts in the fuel cells that use the hydrogen in the reformate.

The catalysts used in reforming typically have a shorter lifespan than other major component in the reformer assembly. Therefore, it may be necessary to change the reformer catalyst within the lifetime of the reformer, or of the fuel cell power system. It is therefore important that the catalyst can be replaced easily. Preferably, it should be possible for the removal of the catalyst to be done by a service technician, and with minimal physical contact by the technician with the catalyst material. It is also desirable that the catalyst be packaged in such a way that it is easy to ship removed catalyst to a catalyst recycling facility. This requires a change from present practice, in which reformers are typically of welded construction to prevent the escape of heat and noxious gases from the reformer.

### SUMMARY OF THE INVENTION

This invention describes a method and apparatus to improve the serviceability of a fuel reformer, particularly when used in an automotive application. A carrier carrying one or more modules is provided. The carrier as a whole is removable from the reformer as a unit. The carrier is connected to the reformer assembly by a reversible connection. The carrier is typically and preferably made from an elongated tube. Examples of suitable shapes for the carrier tube are ovals, cylinders, or rectangles with round edges; cylinders are preferred. Devices such as bolts, a clamp, or other connecting means allowing reversible removal of the carrier are used to secure the carrier to the rest of the reformer. The carrier is preferably included within and surrounded by the rest of the reformer assembly in two dimensions, while being arranged in a third dimension so as to be accessible for removal. Positioning of the assembly in the center of the reformer is preferred, both for heat retention and for simplicity of engagement and disengagement. The modules of the removable carrier, or the carrier itself, may carry any of a variety of catalysts used in reforming or in reformate purification, as well as other components, which may include heat exchangers, insulators, absorbents, mixers, distributors, steam generators, combustors or burners, and other components which may conveniently be placed on a carrier. The carrier will also often carry connectors for connecting to other parts of the system, for example inlets of air, water or fuel, and inlets or outlets of reformate.

In one aspect, a modular fuel reformer of the present invention comprises a fuel reformer assembly comprising a cavity; a removable carrier comprising at least one fuel reformer module, the carrier connecting to the fuel reformer assembly to enclose the at least one module within the cavity; and a connector engageable to secure the carrier and the fuel reformer assembly in fluid-tight relationship and easily disengageable to permit removal of the carrier from the fuel reformer assembly. Any suitable connector can be employed to removably secure the carrier to the fuel reformer assembly, such as a flange with bolt holes, clamps, latches, retaining springs, a threaded connection, nuts and studs, pins, bayonet-type engagements, retaining rings, a chuck or collet, a crimped disposable connector, or any combinations of these. The at least one module preferably comprises a catalyst module containing a catalyst, such as a fuel reforming catalyst, a water gas shift catalyst, a catalyst for removing carbon monoxide or other contaminants, or a catalytic burner catalyst.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 shows a projection and a cross-section of one embodiment of the reformer of the invention with a carrier removed from the reformer;

FIG. 2 shows a cross-section of the assembled reformer of FIG. 1, and enlargement of certain details to illustrate the operation of the device;

FIG. 3 shows an exploded view of a second embodiment of a reformer of the invention with a carrier detached from the reformer; and

FIG. 4 shows a cross-section of the reformer in FIG. 3, as assembled.

### DETAILED DESCRIPTION OF THE INVENTION

A description of preferred embodiments of the invention follows.

In describing the invention, the term “carrier” is used to describe a component of a reformer that is connected to the rest of the reformer (or “the reformer”, for brevity) by readily reversible means. In the simplest embodiment, the carrier may itself be, or consist essentially of, a monolithic catalyst or a contained bed of pelleted catalyst. More generally, the carrier may have several “modules” or functional units, which are often catalyst modules, or modules with other functions, such as heat exchange or gas purification or others as noted above. A catalyst “module” is typically a container of catalyst, or one or more segments of monolithic catalyst. A “monolithic” catalyst is a catalyst in monolithic, i.e., one-piece, form, for example and without limitation, a catalyst impregnated into and/or coated onto ceramic and/or metal shapes, foams, or honeycomb structures, structures made of ceramic and/or metal fibers joined together, or catalysts coated onto structural elements such as heat exchangers.

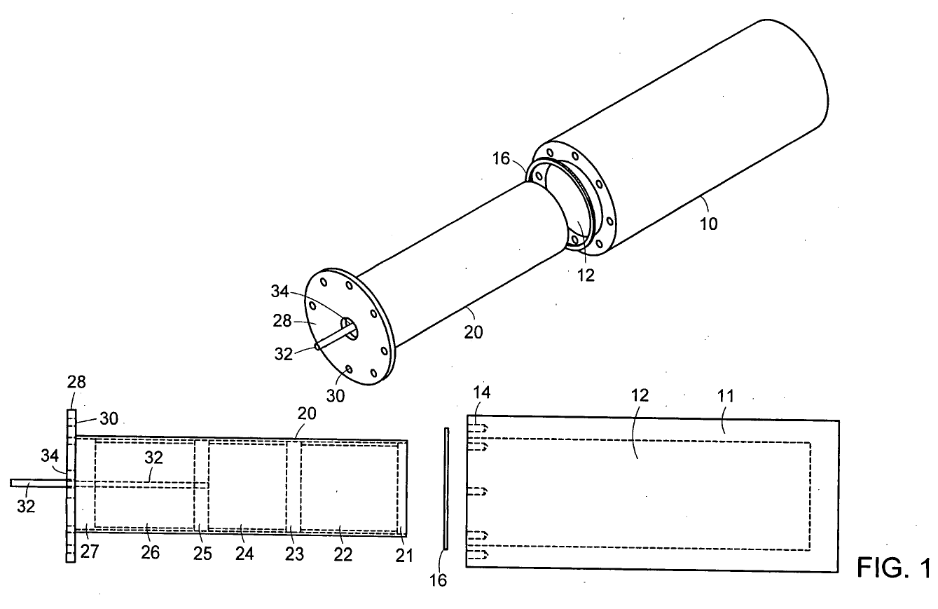

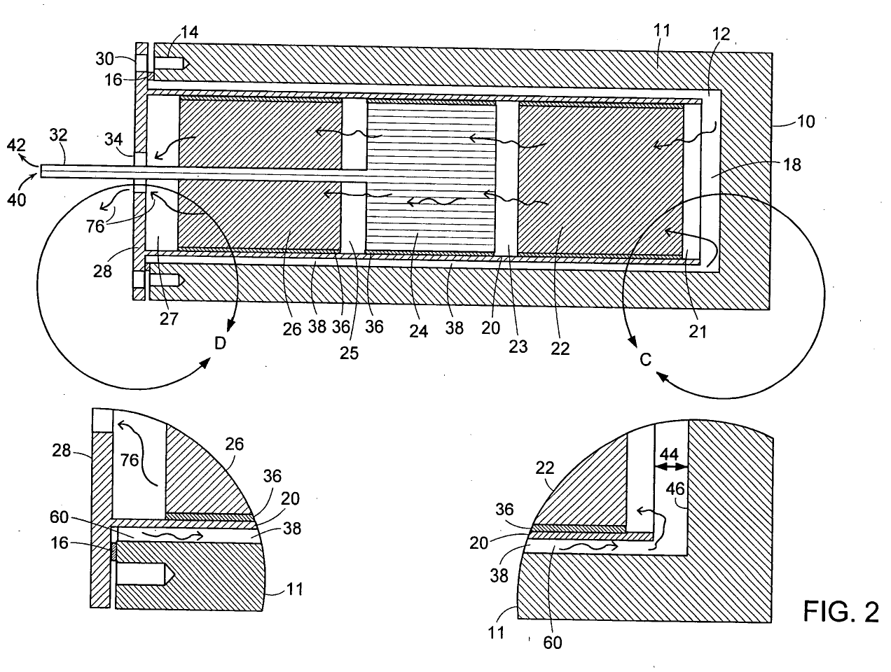

FIGS. 1 and 2 schematically illustrate an embodiment of the invention. The removable carrier is described in more detail below, while the rest of the reformer is illustrated very generally. A fuel reformer assembly 10 according to one embodiment of the invention comprises a wall 11, interior cavity 12, and boltholes 14. It is understood that the reformer will typically includes significant additional components and features not relevant to the principles of the present invention. A gasket 16 is shown between the reformer section 10 and the catalyst carrier 20.

In this embodiment, a carrier 20 is a metal cylinder. Two cylindrical catalyst sections, 22 and 26, are enclosed in the carrier. As illustrated, the catalyst sections are separated by a cooler 24, as might be used, for example, between a reformer section 22 and a high temperature water gas shift unit 26. One end of the cylinder is open, and a space 21 may be provided between the open end of the cylinder 20 and the first catalyst section 22. Other spaces may be provided for mixing, including space 23 between the first catalyst 22 and the cooler 24; a space 25 between the cooler and second catalyst 26; and a space 27 between the second catalyst and the other end of the carrier tube 20, which is partially closed by a flange-bearing end cap 28. The cap has central opening 34, through which cooler connector 32 extends; the outer flange portion has holes 30 for bolting the carrier to the rest of the reformer. Instead of bolts, clamps could be used, or any other reversible connection means.

The modules of catalytic or other function may be secured in the carrier by any convenient means. In this embodiment, fixation is accomplished by wrapping the modular sections in a fibrous ceramic mat 36 (best seen in FIG. 2), and compressing this between the module and the carrier wall. Spacer rings (not illustrated) can be used to maintain the positions of the module sections and the cooler. In another embodiment, not illustrated, a tourniquet arrangement can be utilized to secure the modules. The tourniquet arrangement consists of placing one or more modules in a half of a carrier shell, and subsequently compressing the modules slightly by pressing down a second half shell and fixing it in place. For example, fixation can be done by welding the second half shell of a carrier to the first half shell, or it could be done by clamping. An open end may be provided on one end of the carrier to provide easy access to the catalyst. In general, any suitable means can be used to connect the module to the carrier. The connection between a module and the carrier may or may not be readily reversible. Hence, the units also could be welded in place inside carrier shell 20, or fastened to carrier 20 with fasteners.

It is also possible to assemble a carrier out of modules. In this embodiment, modules are fastened together to form a single assembly, serving the carrier function, which can be removed from the reformer as a unit. The modules can be connected reversibly or irreversibly. For example, and without limitation, a carrier can be formed by connecting modules by screw connections, clamps, welding or swaging.

In any of these assemblies that contain catalyst, it may be convenient to provide a catalyst as a monolithic device, for example as a substrate of an extruded shape, or a metal honeycomb, or a foam, or other porous configuration, coated with a catalyst, often with a washcoat or other intermediate layer to increase effective surface area and catalytic capacity. Such monoliths are particularly preferred for mobile applications, despite their generally greater cost. The catalyst may also be a conventional pelletized catalyst. In such a case, it would typically be packed in discrete lengths of tubing that are closed at the ends by a screen or other porous structure. Alternatively, it could simply be poured into a carrier, or a section of a carrier, and retained by a screen, particularly when the carrier will be upright while in use.

FIG. 2 illustrates the components of FIG. 1 when assembled together, and illustrates some of the possible operations. The insertion of the carrier 20 into the cavity 12 occupies most of the cavity 12, leaving an annular passage 38 and a mixing zone 18. The “blanket” 36 described for reversibly placing the catalyst sections in the carrier is more easily visible in this view, as is the compressed gasket 16. The holes 30 are shown as apposed to the bolt-receiving holes 14; bolts are not shown.

Examples of routes of gas flow through the assembled apparatus are shown with wavy arrows. At the left of FIG. 2, flows of coolant into (40) and out of (42) connector 32 are shown. Alternatively, flow could be only one way at this point—for example, inward if the coolant, such as water or low temperature steam, is injected into the flowing gas stream.

In expanded view D, two wavy arrows are shown. A flow 60 of fuel and steam through passage 38 is shown, as well as an exiting flow 76 of reformate. The source of the flow 60 is not illustrated; it would typically originate from a location elsewhere in the reformer assembly 12 and pass through reformer wall 11. Flow 60 is typically warmed by heat exchange via shell 20 (the wall of the catalyst container) with the high-temperature catalytic elements, such as reforming catalyst 22 and HTS catalyst 26.

As shown in expanded view C, upon reaching the end of shell 20, flow 60 passes through clearance 44 between shell 20 and the inner surface 46 of the reformer wall. It then enters mixing zone 18 and then enters the first catalyst unit 22, which might be a high temperature reforming section. In one embodiment, catalyst 22 could be an autothermal reforming catalyst, and a flow of air (not illustrated) would be introduced into mixing zone 18 so that some of the fuel could be oxidized within catalyst unit 22 to provide the heat required for the endothermic reforming reaction. Air could be introduced along with steam/fuel flow 60, for example. The flow 60, now transformed into unshifted reformate plus carbon dioxide, then flows through unit 24, which in this embodiment typically is a cooler and optionally is a steam generator, and then through a second catalyst bed 26, which in this embodiment typically is a HTS water gas shift catalyst unit. The shifted reformate 76 leaves the catalyst module through opening 34. In a completely detailed reactor design, a collection device in communication with opening 34 would lead the shifted reformate through additional catalysts and eventually into a fuel cell. Reversible connections, such as clamped gaskets or pressure connectors, would connect reformate passage 34 and fluid inlet 32 to other system components.

Another feature of this embodiment is illustrated in FIG. 2. The clearance 44 between the carrier 20 and the reformer wall end 46 can easily be made large enough to accommodate changes in the length of the carrier 20, or the reformer wall 11, upon changes in temperature. In particular, in an embodiment where the hottest zones are in the center of the reformer, as they are in the embodiment described here, the carrier 20 will tend to expand more than the rest of the reformer will. The arrangement illustrated allows for the expected differential expansion of the carrier without requiring an expansion joint, such as a bellows or similar device.

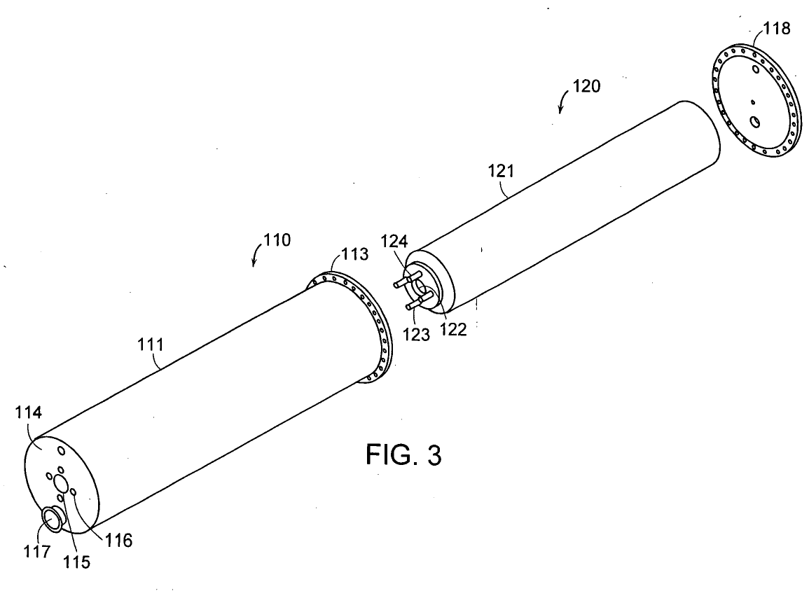

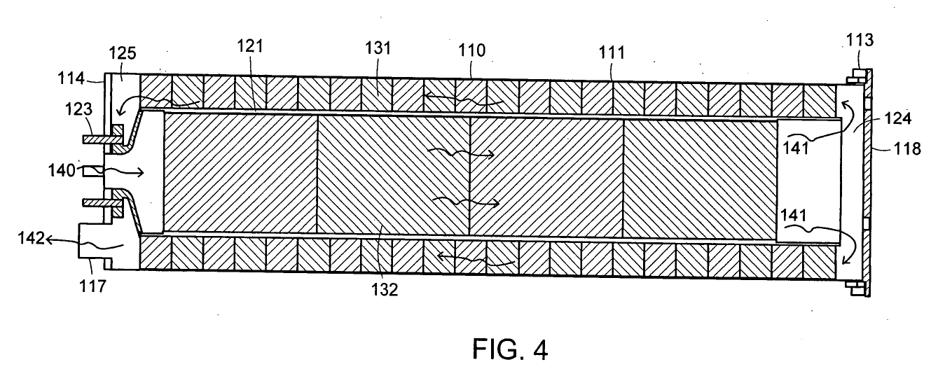

FIGS. 3 and 4 illustrate another embodiment of the invention. In this embodiment, a reformer assembly 110 comprises a cylindrical wall 111, a flange 113 on one end, an end plate 114 on the other end. The end plate 114 has a center hole 115, a plurality of boltholes 116, and a metal fitting 117. Another end plate 118 can be connected to flange 113 to close the reformer. The details of the connection will be described in the following section. A carrier 120 comprised of a metal cylinder 121, and a flange 124 on one end of the cylinder 121, the flange having a center hole 122 and numerous bolts 123 on the flange. FIG. 4 indicates the spatial relationship between the reformer, the carrier, and the catalysts as assembled. The diameter of the carrier cylinder 121 is smaller than the reformer cylinder 111. The carrier cylinder 121 is shorter in length than the reformer cylinder 111. It is designed so that the bolts 123 on the carrier matches the boltholes 116 on the reformer end plate 114. When the bolts 123 are fastened to the boltholes 116, the center hole 122 on the carrier is aligned with the center hole 115 on the reformer. In the cavity between the carrier cylinder 121 and the reformer wall 111 resides catalyst 131. Inside the carrier 120 resides catalyst 132. Both catalysts 131 and 132 may comprise catalyst deposited on the substrates, or catalyst pellets. When an end plate 118 is connected to the flange 113, a fluid passage in a void space 124 is formed between the inner cavity of the carrier 118 and to the space between the carrier 120 and the reformer catalyst 131. Another void space 125 is also formed at the other end of the assembled reformer as shown in FIG. 4. The relation of the reformer with the rest of the system is not shown. Nevertheless, the assembly is in fluid communication with a upstream gas source. Gas flow directions are indicated by wavy arrows in FIG. 4. The gas stream 140 enters the carrier through center holes 115, 122 and comes into contact with catalyst 132, where reactions take place. After reaction, the gas stream 141 flows through the gap 124 between the carrier cylinder 121 and the end plate 118 and comes into contact with catalyst 131, where further reactions take place. The resultant gas stream 142 then enters the void space 125, and subsequently exits the reformer through outlet 117.

The embodiment shown in FIGS. 3 and 4 is particularly advantageous for the “clean-up” reactions of a fuel reformer. For example, catalyst bed 132 in inner cylinder 121 can perform the low temperature part of the water gas shift reaction, and catalyst bed 131 can perform the preferential oxidation (PrOx) reaction to further reduce carbon monoxide levels in the reformate stream. Some possible designs for a PrOx reactor of this configuration (i.e., with a hollow core ) are illustrated in our copending application WO 03/106946, the entire teachings of which are incorporated herein by reference.

Replacement of Catalyst

In the embodiment of FIGS. 1 and 2, removal of the main catalyst section requires disconnecting any attached supply lines, removing the bolts that hold cap/flange 28 to reformer 10, and pulling out the carrier. Either a defective module or the entire carrier can be replaced. The old gasket is removed if required, a new gasket is put in place, and a carrier (new or repaired) is inserted and bolted to the reformer. Other than connectors for reformate outlet 34 and fluid inlet 32, in this embodiment no other connections need to be broken or remade, and no critical clearances are present in the system. In some embodiments, there may also be a removable cover, optionally carrying insulation, shielding the connection zone from outside contaminants, and/or protecting other components from the heat of the reformer, or from any accidental leak of hot, potentially toxic gas. After the carrier is removed from the reformer assembly, the used catalyst can be placed in a shipping container, sealed, and returned for recycling, in particular recovery of precious metals. Alternatively, a particular defective module could be removed from the carrier and replaced, followed by reconnection of the carrier to the reformer. A similar replacement process can be used in the embodiment of FIGS. 3 and 4.

One advantage of the modular fuel reformer of the present invention is that it permits a technician to easily remove and replace catalysts in a fuel reformer by removing and replacing the entire carrier, or a module, without having to physically touch or handle the catalyst material.

Connectors

The connection method has been illustrated as proceeding via connection of the carrier to the reformer assembly by a set of bolts. However, the method of connection is not critical, and any connection method that produces a sufficiently fluid-tight, non-leaking connection is suitable. The other key feature of the connection means, besides not leaking gas or other fluids, is that the connection be readily releasable after extended service. Prolonged use of a high temperature module or carrier is likely to produce some corrosion, and perhaps a certain amount of warping and/or accumulation of debris. Preferred connection methods will still allow easy removal of the carrier after such events.

Hundreds of types of connectors can be found in standard catalogs of mechanical parts and the like, and any of these may potentially be a suitable means for making the connection between the carrier and the reformer. Other methods include, without limitation, a clamp, such as a tapered clamp or a band clamp (optionally with an insert to adapt a clamp to features on the reformer or carrier); one or more latches; one or more springs; a threaded connection; nuts and a set of studs; pins, including cotter-type pins; bayonet-type engagements; snap-in retaining rings; snap-on retaining rings; a chuck or collet; and combinations of these.

Semi-reversible connections can also be used to obtain the same functionality, i.e., easy changing of catalysts or other functional fuel reformer modules. Among these semi-reversible means are reversible crimps, for example as encountered in bottle caps, which must be pried open for release, and a new one used for reconnection; and some types of snap-on or crimped retainers that must be cut to obtain release of the components (for example, a clamp that is crimped shut and later cut, as is sometimes used in closure of drums). The semi-reversible connection is easy to operate in a service environment, and only an inexpensive, easily replaceable component, such as a steel band, need be destroyed.

The selection of retaining means will be governed to some extent by the pressure encountered inside the reformer. In an unpressurized reformer, there will be a wide variety of possible closures; in a reformer pressurized to a few atmospheres, there will be almost as wide a variety. In highly pressurized reformers, applying a reversible sealing means for an operating period that may be measured in months will probably require more careful engineering to maintain pressure, as will other joints in the system.

Alternative Embodiments

In a reformer, in addition to a primary reforming catalyst, which may be a catalyst for a steam reforming reaction, an autothermal reforming reaction, and/or a partial oxidation reaction, there are typically at least two stages of catalyzed water gas shift (high temperature and low temperature), and in many cases one or more selective catalysts for final stages of carbon monoxide removal. Moreover, there is often a burner for “waste” gas, and for steam reforming there is typically an exogenous burner to supply heat to the reforming catalyst unit, sometimes different from the waste gas burner; such burners may also be catalytic.

As illustrated in the embodiment described above, it is especially convenient to use a central location in a reformer for a removable catalyst carrier. It is also typically desirable to place the highest temperature reactions in or near the center of a reformer, to minimize heat loss. Hence, the configuration described here will often be preferred, although there is no particular reason that the carrier might not be configured to be the reverse of that shown above, with the reforming module at the “easily opened” end, and the shift catalyst further inside. In either case, a catalytic burner associated with a reformer could be placed in the same module, either in line with, or partially or completely surrounding, a reforming catalyst unit. Depending on the form factor (i.e., ratio of length to diameter), it might be possible to also place additional catalytic units in the same carrier, such as a low temperature shift catalyst, and even a carbon monoxide removal catalyst. Alternatively, a carrier might carry only one module, in which case the module could be fabricated as a carrier, i.e., carrying connectors for forming a reversible connection.

Moreover, catalysts could be located in separate carriers. For example, a second carrier could be concentric with a first carrier—surrounding it, or in its center—and could be rendered easily removable by similar design principles. For example, such a carrier could carry lower-temperature modules, such as the low temperature water gas shift catalyst, or a preferential oxidation CO removal catalyst. Alternatively, other catalysts could be in a separate section of a reformer, perhaps commonly housed with a first section of a reformer. Catalyst or other modules could be placed in a carrier in the separate reformer section as well.

In addition, the structures described here as “catalyst modules” may also or instead comprise catalytic burners, or catalytic units for impurity removal. And, as noted previously, modules in a carrier may carry out non-catalytic functions, for example non-catalytic combustion, steam generation, heat exchange, impurity absorption, mixing, fluid distribution, or insulation.

An important advantage of the module carrier is that it separates the catalyst or other modules from the necessary connections of the reformer to its surroundings, thereby simplifying the connection of the catalyst carrier to the reformer. The reformer as a whole must provide connections, in one location or another, to sources of fuel, air, and water, as well as to sensors and control elements, and to other system components such as pumps, blowers, and the like. Careful system design is essential to enable the less durable components of a fuel reformer to be replaced easily, and the placement of the catalytic components in an easily detachable carrier is an important aspect of constructing an easily serviced reformer.

While this invention has been particularly shown and described with references to preferred embodiments thereof, it will be understood by those skilled in the art that various changes in form and details may be made therein without departing from the scope of the invention encompassed by the appended claims.

What is claimed is:

1. A modular fuel reformer comprising:
a fuel reformer assembly comprising a cavity;
a removable carrier comprising at least one fuel reformer module, the carrier connecting to the fuel reformer assembly to enclose the at least one module within the cavity; and
a connector engageable to secure the carrier and the fuel reformer assembly in fluid-tight relationship and easily disengageable to permit removal of the carrier from the fuel reformer assembly.

2. The modular fuel reformer of claim 1, wherein the at least one module comprises a catalyst.

3. The modular fuel reformer of claim 2, wherein the catalyst comprises at least one of a fuel reforming catalyst, a water gas shift catalyst, a catalyst for removing carbon monoxide or other contaminants, and a catalytic burner catalyst.

4. The modular fuel reformer of claim 1, wherein the removable carrier comprises a portion extending outside the cavity to facilitate removal of the carrier from the fuel reformer assembly.

5. The modular fuel reformer of claim 1, wherein the carrier and the cavity are generally cylindrically shaped, and the carrier fits concentrically within the cavity.

6. The modular fuel reformer of claim 1, wherein the carrier comprises a flange that contacts a surface of the fuel reformer assembly to connect the carrier to the fuel reformer assembly.

7. The modular assembly of claim 6, further comprising a gasket positioned between the flange and a surface of the fuel reformer assembly.

8. The modular assembly of claim 1, wherein the connector comprises at least one of a flange with bolt holes, a clamp, a latch, a retaining spring, a threaded connection, a nut and stud, a pin, a bayonet-type engagement, a retaining ring, a chuck or collet, and a crimped disposable connector.

9. The modular assembly of claim 2, wherein the interior of the fuel reformer cavity comprises a catalyst.

10. The modular assembly of claim 9, wherein the module catalyst is adapted to facilitate a low temperature water gas shift reaction, and the catalyst on the interior of the fuel reformer cavity is adapted to perform a preferential oxidation reaction.

11. A method for improving the serviceability of a fuel reformer, wherein the reformer contains one or more functional modules requiring service, the method comprising the steps of:
placing at least one module in a carrier; and
providing one or more connecting means for connecting the carrier to the remainder of the reformer, wherein the connecting means are selected to allow the connection between the carrier and the reformer to be made and broken in a reversible manner.

12. The method of claim 11 wherein a module comprises a catalyst.

13. The method of claim 12 wherein a catalyst is in pelletized form.

14. The method of claim 12 wherein the catalyst is supported on a monolithic substrate.

15. The method of claim 11 wherein the carrier is a removable piece that has at least a portion of the connection means at one end of the carrier.

16. The method of claim 11 wherein the carrier is concentric with the reformer.

17. The method of claim 11 wherein the carrier is concentric with at least one section of a reformer having more than one section.

18. The method of claim 11 wherein the carrier comprises one or more modules having functions selected from non-catalytic combustion, steam generation, heat exchange, impurity absorption, mixing, fluid distribution, and insulation.

19. The method of claim 11 wherein the connecting means between the carrier and the remainder of the reformer comprises at least one of a flange with bolt holes, a clamp, a set of latches, a set of retaining springs, a threaded connection, nuts and a set of studs, pins, bayonet-type engagements, retaining rings, a chuck or collet, a disposable piece providing a crimped connector that can be uncrimped or cut to allow removal of the carrier; and combinations of these.

20. The method of claim 11 wherein the modules are secured to the carrier by a reversible means.

21. The method of claim 11 wherein the catalyst modules are secured to the carrier by an irreversible means.

22. The method of claim 11 wherein the carrier is a catalyst module.

23. The method of claim 11 wherein the carrier consists of two halves and at least one module is placed in the perimeter of the first half, and then the second half is joined to the first half, compressing the module so as to retain it in place.

24. The method of claim 11 where a module contains a catalyst selected from a reforming catalyst, a water gas shift catalyst, a carbon monoxide removal catalyst, a catalytic burner catalyst, and a contaminant removal catalyst.

25. A fuel reformer, the reformer characterized in having at least one functional module mounted in a carrier, wherein the carrier is arranged so that it can be removed from the reformer by the disconnection of reversible connection means.

26. The reformer of claim 25 in which the connection means between the carrier and the reformer comprises at least one of a flange with bolt holes, a clamp, a set of latches, a set of retaining springs, a threaded connection, nuts and a set of studs, pins, bayonet-type engagements, retaining rings, a chuck or collet, a disposable piece providing a crimped connector that can be uncrimped or cut to allow removal of the carrier; and combinations of these.

27. The reformer of claim 25 wherein a module contains a catalyst selected from a reforming catalyst, a water gas shift catalyst, a carbon monoxide removal catalyst, a catalytic burner catalyst, and a contaminant removal catalyst.

28. The reformer of claim 25 wherein a module has a function selected from non-catalytic combustion, steam generation, heat exchange, impurity absorption, mixing, fluid distribution, and insulation.

29. The reformer of claim 27 wherein the catalyst is supported on a monolithic substrate or is in pelletized form.
